(19) United States
(12) Patent Application Publication
(10) Pub. No.: US 2013/0329451 A1
(43) Pub. Date: Dec. 12, 2013

(54) SURGICAL LIGHT WITH LED LIGHT GUIDING AND FOCUSING STRUCTURE AND METHOD

(71) Applicants: Falcon Lin, Taoyuan County (TW); Cheng-Yi Huang, Taoyuan County (TW); Sung-Min Lin, Taoyuan County (TW)

(72) Inventors: Falcon Lin, Taoyuan County (TW); Cheng-Yi Huang, Taoyuan County (TW); Sung-Min Lin, Taoyuan County (TW)

(21) Appl. No.: 13/602,158

(22) Filed: Sep. 1, 2012

(30) Foreign Application Priority Data
Jun. 11, 2012 (TW) 101121042
Jul. 26, 2012 (TW) 101126942

(51) Int. Cl. F21V 8/00; F21V 14/04; F21V 14/02

(52) U.S. Cl. 362/602; 362/612; 362/608

(57) ABSTRACT

A surgical light includes a light guide plate and a plurality of LEDs. The light guide plate has a light incident surface, a reflecting surface and a light exit surface. The reflecting surface defines an optical axis passing through the center of the light guide plate. A plurality of reflecting structures are formed on the reflecting surface, and are distributed symmetrically about the optical axis. The light emitted by the plurality of LEDs enters the light guide plate in the same direction, is then reflected by the reflecting structures, and exits from the light exit surface. The exited light defines a plurality of focal points, which are spaced apart from the conducting plate at different distances and cooperatively define a predetermined depth of focus so that an object within the depth of focus can receive adequate luminous intensity.

### BACKGROUND OF THE INVENTION

1. Field of the Invention

The present invention relates to a medical illumination unit, more particularly, relates to a surgical light with the light guide plate(s) which guide the light rays to a given spot and create a long and continuous focal length.

2. The Prior Arts

Surgical light is a very important illumination unit used during surgical operations. It is essential to have appropriate lighting that helps the surgeon see clearer into a surgical cavity and tell the differences in blood vessels and organs. Surgical light requires a maximum shadow reduction feature and is different from general lightings. Conventional surgical light uses single light source which cause inadequate illumination therefore brings problems during surgeries. Such problems include insufficient illumination of the surgical field which contributes to the surgeon's eye fatigue. There are other types of surgical lights uses multiple light sources along with a plurality of reflectors or lenses. However, the depth of illumination of multiple light source surgical light is inadequate for long distance illumination needed in some surgical specialties.

### SUMMARY OF THE INVENTION

The conventional surgical light employs multiple light sources fixed at various angles and coordinated to superimposed on a given area as its illuminating method, and have a primary drawback of short focal length. Flexibility is eliminated and utilization of the light is severely restricted.

Hence, a primary object of the present invention is to provide a surgical light which includes a light guide plate and a plurality of light emitting diodes (LEDs). The light guide plate is a plate includes a light incident surface, a reflecting surface and a light exit surface. The reflecting surfaces define an optical axis, which passes through the center of the circularly surrounding light guide plates. A plurality of reflecting structures are formed on the reflecting surface of the light guide plate, and are distributed symmetrically around the optical axis. The plurality of LEDs are disposed at a predetermined location near the light incident surface of the light guide plate. The light emitted by the plurality of LEDs enters the light guide plate in the same direction and is reflected by the reflecting structures and then exits from light exit surface. The exit light define a plurality of focal points located along the optical axis, which are spaced apart from one another, which are spaced apart from the light guide plate at different distances and which cooperatively define a long predetermined depth of focus so that an object disposed within the long predetermined depth of focus can receive adequate luminous intensity.

More preferably, each of the plurality of reflecting structures is a three-dimensional geometric structure symmetric about the optical axis.

More preferably, each of the plurality of reflecting structures is a trapezoidal structure.

More preferably, the plurality of LEDs are installed on the light guide plate.

More preferably, the plurality of LEDs are installed on one side edge of the light guide plate.

More preferably, the plurality of LEDs are located between the center of the light guide plate and the plurality of reflecting structures.

More preferably, an opening is formed at the center of the light guide plate.

More preferably, a plurality of optical components are installed between the light incident surface and the plurality of LEDs.

More preferably, the light guide plate is a one-piece integral member or a plate assembled with several pieces of smaller plates.

Another purpose of the present invention is to provide an LED focusing method, comprising: providing a plurality of radially arranged LEDs adjusting modules, wherein each LED adjusting module includes an LED and a light guide plate, where the LED is located on the same level as the light guide plate. The LED is provided with an optical member, so that the light is emitted by the LED radiate towards the light guide plate, and the light guide plate radiates the light in a predetermined direction, so the light emitted by each LED adjusting module focus and forms a predetermined focal range; adjusting the LED or the light guide plate in such manner that it is tilted at a predetermined angle relative to the horizontal plane, so the light incident angle from the LED at the light guide plate is adjusted, and the focus location of the light emitted by each LED adjusting module and the predetermined focus range thereof is changed

More preferably, an end of the light guide plate adjacent to each LED is provided with a revolving axle, so the rotation of the light guide plate is adjusted through the revolving axle while a distal end of the light guide plate away from each LED is provided with a rod. The rod is connected to an adjusting member, so the rotation of each light guide plate is adjusted through the adjusting member.

More preferably, the abovementioned method further can be used in a medical illumination device.

Another purpose of the present invention is to provide an LED focusing structure, comprising: a plurality of radially arranged LED adjusting modules, each LED adjusting module comprises: an LED; and a light guide plate; wherein the LED and the light guide plate are located on the same level, the LED is provided with an optical member, so that the light emitted by the LED radiates in the same direction towards the light guide plate, and the light is then reflected in a predetermined direction so as to form a predetermined focus range; each light guide plate is tilted by an adjusting mechanism respectively at a predetermined angle relative to the horizontal plane, so the light incident angle from the LED toward the light guide plate is adjusted, and the predetermined focus range thereof is changed.

More preferably, the adjusting mechanism is provided by installing a revolving axle at an end of the light guide plate adjacent to each LED so the rotation of the light guide plate is adjusted with the revolving axle; a distal end of the light guide plate away from the respective LED is provided with a rod, the rod is connected to an adjusting member, so the rotation of each light guide plate is adjusted through the adjusting member.

More preferably, the LED focusing structure can be applied to a medical illumination device.

Through the techniques used in the present invention, the illuminated object can receive adequate luminous intensity within the range of the depth of focus of the surgical light. The production cost of light guide plate can also be lowered by using several pieces of smaller plates for assembling. Moreover, the above described structure is also suitable to be applied to medical illumination devices such as surgical light with high illuminating needs. With the use of the structure, the illuminated area can be adjusted according to different location and height on the patients during medical operations, therefore the illuminating intensity, illuminated area and depth of focus can be efficiently controlled.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a schematic side view showing a first preferred embodiment of the surgical light of the present invention;

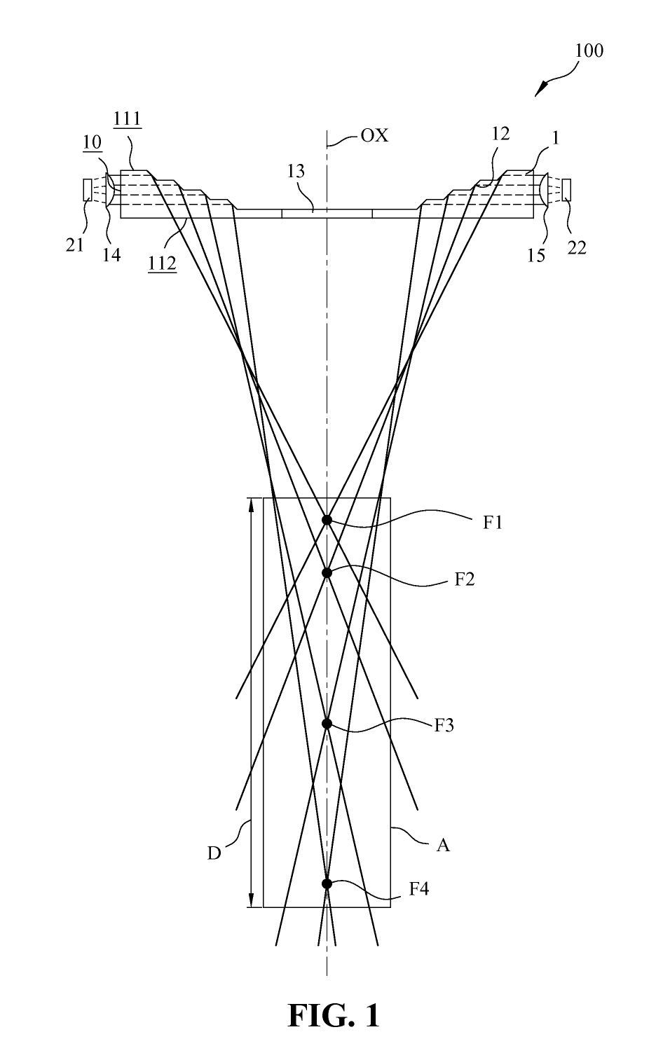

FIG. 2 is a partial section view of the surgical light of the present invention;

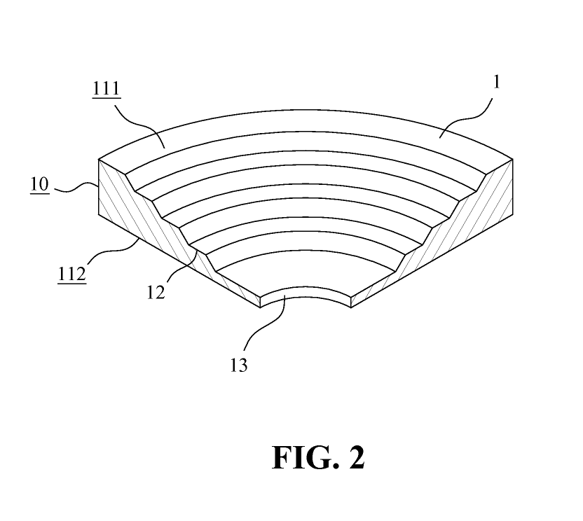

FIG. 3 is another angle of the partial section view of FIG. 2;

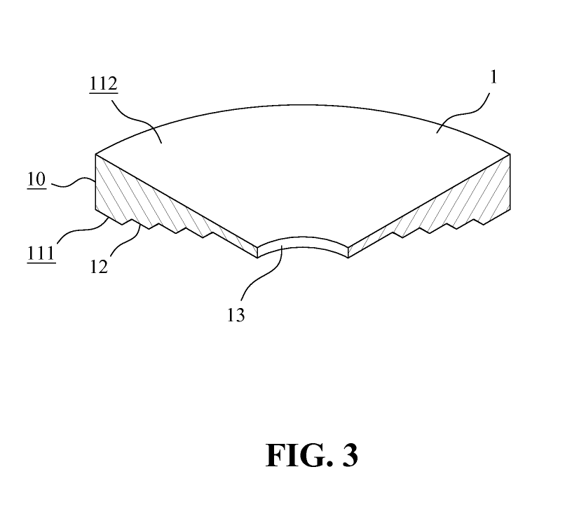

FIG. 4 is a schematic view of the light coverage of the surgical light of the present invention;

FIG. 5 is a second preferred embodiment of the surgical light of the present invention;

FIG. 6 is a third preferred embodiment of the surgical light of the present invention;

FIG. 7 is a bottom view of the LED focusing structure of the present invention;

FIG. 8 is a schematic view of the LED adjusting module;

FIG. 9 is a schematic view of the forming of the illuminated area (predetermined focus range) by the LED adjusting module; and

FIG. 10 is a schematic view of the adjusting of the illuminated area (predetermined focus range) through the LED adjusting module.

### DETAILED DESCRIPTION OF THE PREFERRED EMBODIMENTS

A surgical light of the present invention includes a light guide plate 1 and a plurality of LEDs 21 and 22. The light guide plate 1 has a center, a light incident surface 10, a reflecting surface 111 and a light exit surface 112. The reflecting surface 111 defines an optical axis OX passing through the center of the light guide plate 1. A plurality of reflecting structures 12 are formed on the reflecting surface 111 of the light guide plate 1, and are distributed symmetrically about the optical axis OX. The plurality of LEDs 21 and 22 are disposed at a predetermined location near the light incident surface 10 of the light guide plate 1. A plurality of optical components 14 and 15 are installed between the light incident surface 10 and the LEDs 14 and 15. Preferably, the optical components 14 and 15 are collimators, which can converge the large light divergence angle of LED 21 and 22 into a smaller and more suitable light with smaller light divergence angle (nearly parallel). The light beams emitted from the LED 21 and 22 enter the light incident surface 10 in the same direction. The light beams are then reflected by the reflecting structures 12 and exits from light exit surface 112. The exited light beams respectively converge to a plurality of focal points F1, F2, F3 and F4 along the optical axis OX and are spaced apart from one another and are spaced apart from the light guide plate 1 at different distances. The plurality of focal points F1, F2, F3 and F4 further cooperatively define a predetermined depth of focus (D) so that an object disposed within the predetermined depth of focus (D) can receive adequate luminous intensity.

In the first preferred embodiment of the present invention, the reflecting structures 12 forms a circular staircase structure around the center of the reflecting surface 111 of the surgical light 100 from the inside out. Each circular staircase structure has a predetermined interval, depth and slope angle relative to the bottom surface of the light guide plate 1 so that the light beam reflected from each of the staircase structure converges to a focal point different from one another along the optical axis OX or at different locations. The intervals between each circular staircase structure can be equally or differently distanced based on the situations, and the slope angle can be designed according to the desired focus location. Although the preferred embodiment utilizes the circular staircase structure, the reflecting structure 12 in the present invention is not limited thereto. The reflecting structure 12 can also be a symmetrical polygon structure or a symmetrical geometric structure. Furthermore, the light incident surface 10 in the preferred embodiment is the top face of the light guide plate 1. The LED 21 and 22 are installed near the light incident surface 10, in other words, adjacent to one side surface of the light guide plate 1. Preferably, the LED are configured circularly (other symmetrical geometric configuration also works), but only two LED are shown in the graph. The LED stands for the light emitting diode, which includes all types and colors of the LED developed, but the actual installed LED can be chosen according to the required colors and temperatures to reduce colored shadows. Moreover, an opening 13 is formed at the center of the surgical light 100 (i.e., the light guide plate) so that a height adjusting handle can be installed here in the future (preferably a sanitized handle) for height adjustment of the surgical light.

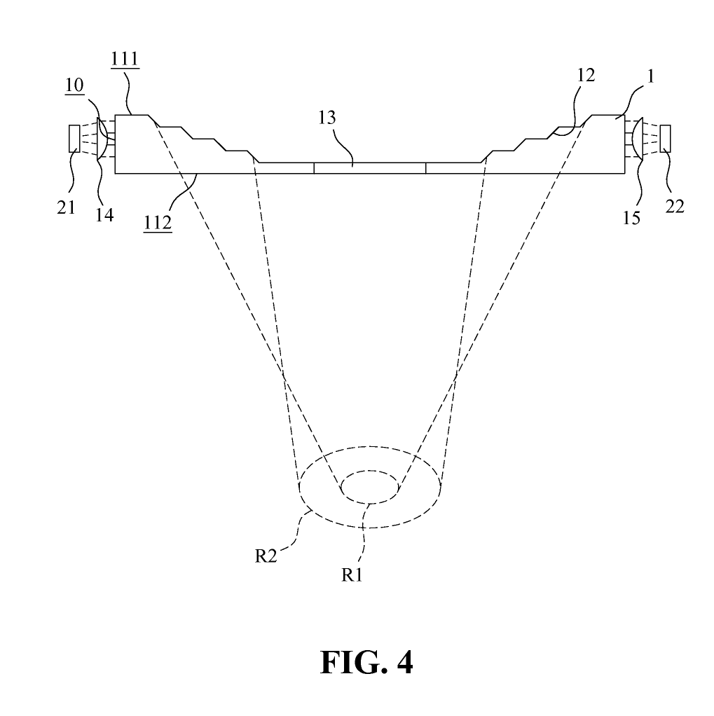

As shown in FIG. 4, the predetermined focus range (or illuminated area) R1 and R2 can be adjusted according to the size of the surgical cavity, and several adjustment methods are listed as below:
a. By adjusting the predetermined angle (tilt angle) of the LED relative to a horizontal plane (i.e., the light incident surface) of the light guide plate through the collimator can change the size of the predetermined focus range (illuminated area) R1 and R2.
b. By using two sets of different collimators, the light beams can enter the incident surface of the light guide plate in different converge angles, or the amount of the electricity in the respective LED can also be adjusted in relative to the illuminated area R1 and R2.
c. By setting the diffuser plate between the collimator and the light guide plate, the range of the incident angle at the light guide plate can be adjusted (for example, from +/−4 degrees to +/−7 degrees).

The methods listed above are for illustration purposes only, and the scope of the present invention is not limited thereto. Any other methods which can achieve the abovementioned goals with prior arts are still in the scope of the present invention.

The production of the light guide plate 1 can be plastic injection molding, or the light guide plate 1 may include smaller pieces fabricated by separate plastic extrusion or injection molding and the smaller pieces are later assembled to form the light guide plate. The material of the light guide plate 1 can be selected from usual optical material such as PMMA resin, COP and PC, or other suitable materials. These different processes and material used will not affect the scope of the present invention, which is the structure of the surgical light.

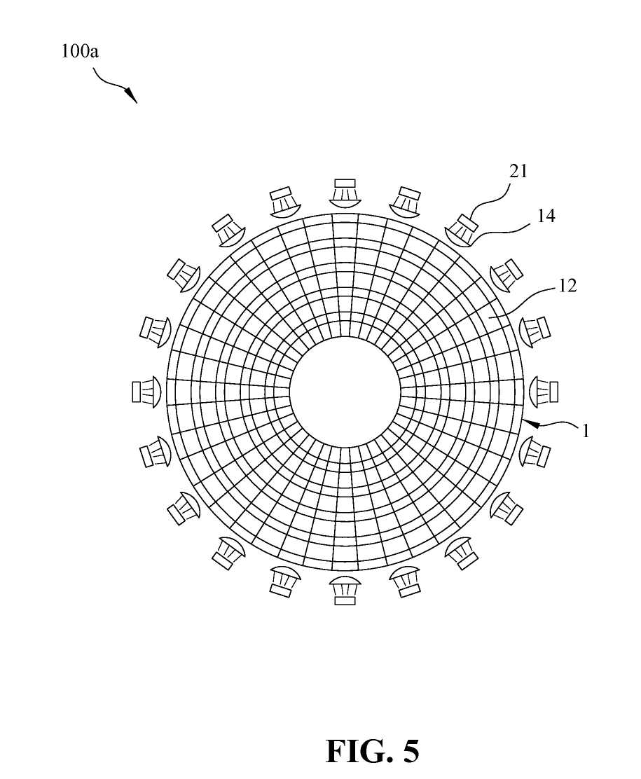

FIG. 5 shows the second preferred embodiment of the present invention. As described previously, the light guide plate 1 of the surgical light 100a can be divided into smaller pieces first, and then assembled into a circular plate. The complete circular plate is then installed with the corresponding light conducting structure, optical component 14 and LED 21 to perform the previous described functions.

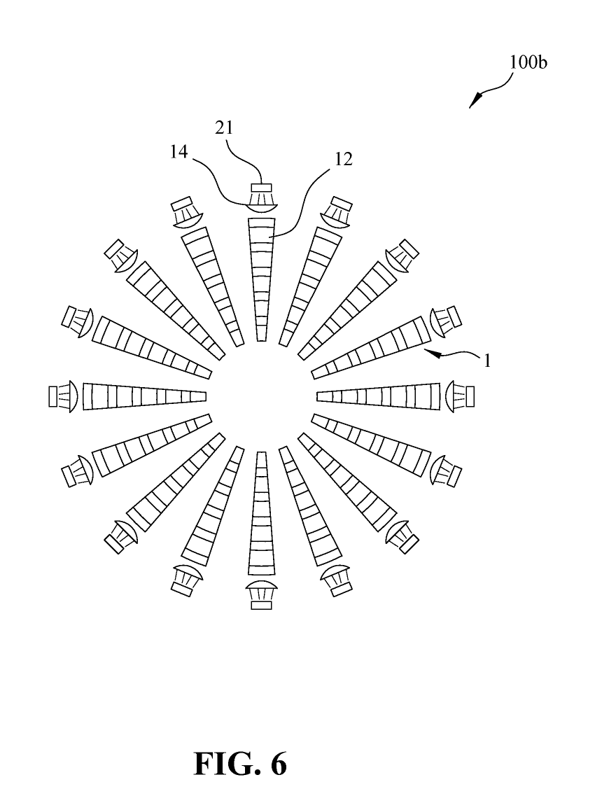

FIG. 6 shows the third preferred embodiment of the present invention. Similarly, the light guide plate 1 of the surgical light 100b can be divided into smaller pieces, where each piece is installed with corresponding light conducting structure, optical component 14 and LED 21. Each piece serves as a module, and a plurality of modules forms the surgical light 100b of the third preferred embodiment. The shape of each piece can be designed based on different situations, for example, the pieces of smaller plates are designed as radial strips in this preferred embodiment. However, the shape of the pieces is not limited thereto, and can be other geometric shape symmetrically configured about the optical axis.

The production process described in the second and the third preferred embodiment above are for the purpose of lowering the production cost. The actual production of the light guide plate can be either one-piece integral member or assembled with pieces of smaller plates based on the situation. The shape, size and arrangement of each piece of smaller plate can be adjusted accordingly, and is not limited to the ones disclosed in the present invention.

### LED Focusing Structure

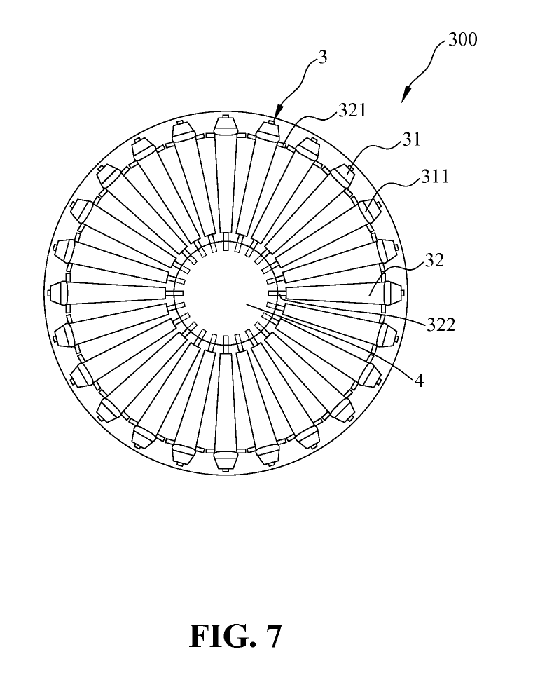

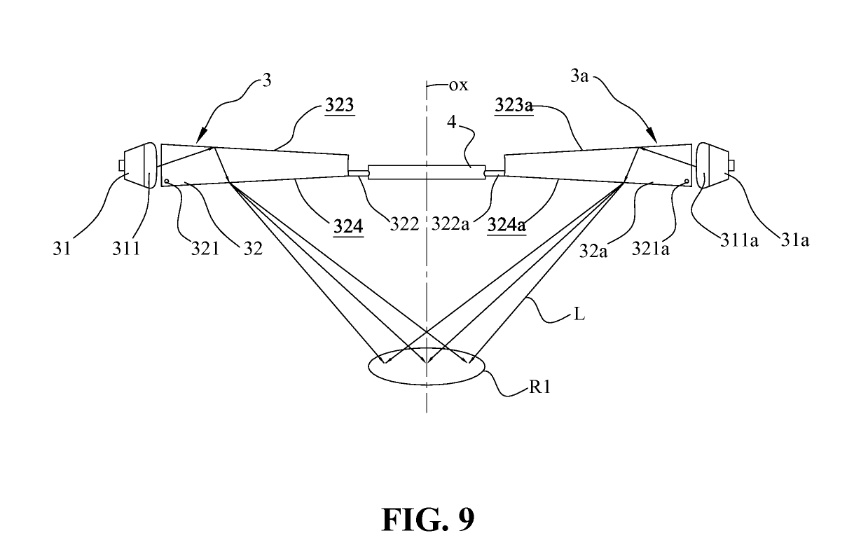

FIG. 7 shows a bottom view of the LED focusing structure of the present invention. The preferred embodiment discloses an LED focusing structure 300, comprising: a plurality of radially arranged LED adjusting modules 3, each LED adjusting module 3 includes: an LED 31 and a light guide plate 32. The LED 31 and the light guide plate 32 are located on the same level. The LED 31 is provided with an optical member 311 (preferred to be a collimator), which can converge the large light divergence angle of LEDs 31 into a smaller and more suitable light with smaller light divergence angle (nearly parallel); then, the light is radiated to the light guide plate 32. Next, the light guide plate 32 radiates the light in a predetermined direction, so that the light L emitted by each LED adjusting module 3 focuses and forms a predetermined focus range (or illuminated area) R1, as shown in FIG. 9.

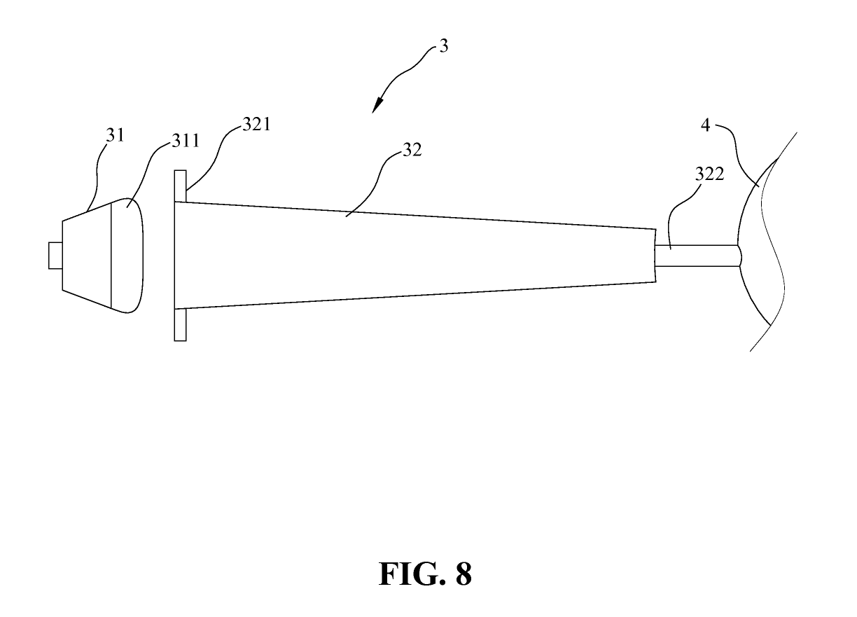

FIG. 8 shows a schematic view of the LED adjusting module. FIG. 8 is illustrated with a single LED adjusting module 3. The rotation of the light guide plate 32 can be adjusted through an adjusting member by installing a revolving axle 321 at one end of the light guide plate 32 proximate to the LED 31. The light guide plate 32 further has a distal end away from the LED 31 and is provided with a rod 322. In this embodiment the rod 322 is connected to the adjusting member 4, so the rotation of each light guide plate 32 can be adjusted by raising or lowering the adjusting member 4.

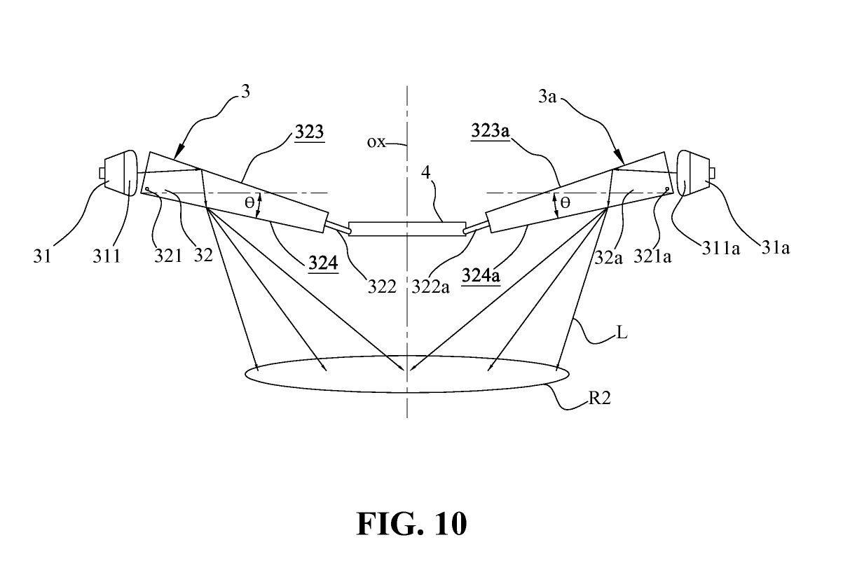

FIG. 9 and FIG. 10 show the forming and adjusting of the illuminated area formed by the LED focusing structure. FIG. 9 is illustrated with a pair of LED adjusting module 3 and 3a which are located symmetrically. The configuration of the LED adjusting module 3 and 3a is the same as the abovementioned configuration, which respectively comprises: an LED 31 and 31a, and a light guide plate 32 and 32a. The closer end to the LED 31 and 31a of the light guide plate 32 and 32a is installed with a revolving axle 321 and 321a; the further end from the LED 31 and 31a thereof is disposed with a rod 322 and 322a. The rod 322 and 322a is linked and connected to an adjusting member 4. The top of the light guide plate 32 and 32a is the reflecting surface 323 and 323a, where the incident light fully reflects within. The bottom of the light guide plate 32 and 32a is the light exit surface 324 and 324a, where the light L exits to provide illumination. Through various light exit angles, the light L focuses at various locations to form an illuminated area R1 (also the predetermined focus range).

As shown in FIG. 10, the illuminated area can be adjusted by raising or lowering the adjusting member 4 (lowering in FIG. 10), which is linked to the light guide plate 32 and 32a. The light guide plate 32 and 32a are tilted to a predetermined angle θ relative to the horizontal plane, so the incident angle of the light emitted by LED 31 at the light guide plate 32 can be changed, and also the focus location and illuminated area of each LED adjusting module 3 can be changed. As shown in FIG. 10, a larger illuminated area R2 is formed through the previous described adjustment.

### LED Focusing Method

Through the above description of the LED adjusting module 3 (for structure please refer to the previous description and FIGS. 7-10), the present invention further discloses an LED adjusting method which can be preferably applied to a medical illumination device such as the surgical light. The method comprises: providing a plurality of radially arranged LED adjusting modules 3, wherein each LED adjusting module 3 includes an LED 31 and a light guide plate 32, where the LED 31 is located on the same level as the light guide plate 32; the LED 31 is provided with an optical member 311, so that the light L is emitted by the LED 31 in the same direction towards the light guide plate 32, and the light guide plate 32 radiates the light L in a predetermined direction so that the light L emitted by each LED adjusting module 3 focuses and forms an illuminated area or a predetermined focus range R1; adjusting the LED 31 or the light guide plate 32 in such manner that it is tilted at a predetermined angle θ relative to the horizontal plane, so that the light incident angle of the light L emitted by the LED 31 at the light guide plate 32 is adjusted, and the focus location of the light L emitted by each LED adjusting module 3 and the illuminated area or the predetermined focus range R1 thereof is changed.

More preferably, a closer end to the LED 31 of the light guide plate 32 of each LED adjusting module 3 is provided with a revolving axle 321, so the rotation of the light guide plate 32 of each LED adjusting module 3 is adjusted through the revolving axle 321; a further end from the LED 31 of the light guide plate 32 of each LED adjusting module 3 is connected and linked to an adjusting member 4, so the rotation of each light guide plate 32 is adjusted through the adjusting member 4.

The structure and method described above are only for exemplary purpose, the configuration of each element can be varied depending on the actual needs and the present art. For example, the manufacturing process of the light guide plate can be either single injection molding with plastic or multiple injection molding with plastic, and the material used can be the common optical material such as PMMA resin, COP and PC, or any other material that is suitable for making the light guide plate; however, these different processing techniques and material used do not affect the scope of the present invention, which is the overall structure of the surgical light. Furthermore, for example, the location of the revolving axle is not limited to the location shown in the figures, which is near the bottom. The revolving axle can also be installed near the top surface, midsection or other locations which are close to or away from the LED, as long as it can adjust the tilt angle of the light guide plate. Relatively, the relative location of the LED to the light guide plate can be adjusted through an adjusting mechanism, such as by installing a revolving axle or other fine tuning mechanism with the same function. The described adjusting mechanism can be design with various mechanical structures provided by the present art, and can be manually operated or electrically controlled. The structure and method of the present invention are suitable to be applied to a medical illumination device such as surgical light with high illuminating needs. With the use of the structure and method, the illuminated area can be adjusted according to different location and height on the patients during medical operations, therefore the illuminating intensity, illuminated area and depth of focus can be efficiently controlled. The structure and method of the present invention have not been seen in any prior arts, therefore should be patentable.

From the abovementioned preferred embodiments, the surgical light does have its value in the industry. However, the preferred embodiment described above is disclosed for illustrative purpose but to limit the modifications and variations of the present invention. Thus, any modifications and variations made without departing from the spirit and scope of the invention should still be covered by the scope of this invention as disclosed in the accompanying claims.

What is claimed is:

1. A surgical light comprising:
a light guide plate having a center, a light incident surface, a reflecting surface and a light exit surface, the reflecting surface defining an optical axis passing through the center of the light guide plate,
a plurality of reflecting structures formed on the reflecting surface of the light guide plate, and distributed symmetrically about the optical axis; and
a plurality of light emitting diode (LED) disposed at a predetermined location near the light incident surface of the light guide plate for emitting a plurality of light beams toward the light incident surface;
wherein, said light beams emitted from the plurality of LEDs enter the light incident surface in the same direction and are reflected by the reflecting structures and then exits from the light exit surface so as to define a plurality of focal points located along said optical axis, said focal points being spaced apart from one another and being spaced apart from said light guide plate at different distances along said optical axis and cooperatively defining a predetermined depth of focus such that an object disposed within said predetermined depth of focus can receive adequate luminous intensity.

2. The surgical light as claimed in claim 1, wherein each of the plurality of reflecting structures is a three-dimensional geometric structure.

3. The surgical light as claimed in claim 1, wherein each of the plurality of reflecting structures is a trapezoidal structure.

4. The surgical light as claimed in claim 1, wherein the plurality of LEDs are installed on the light guide plate.

5. The surgical light as claimed in claim 1, wherein the plurality of LEDs are installed on one side edge of the light guide plate.

6. The surgical light as claimed in claim 1, wherein the plurality of LEDs are located between the center of the light guide plate and the plurality of reflecting structures.

7. The surgical light as claimed in claim 1, wherein the light guide plate is further formed an opening at the center thereof,

8. The surgical light as claimed in claim 1, wherein a plurality of optical components is installed between the light incident surface and the plurality of LEDs.

9. The surgical light as claimed in claim 1, wherein the light guide plate is a one-piece integral member or includes several pieces of smaller plates assembled together in order to form the same.

10. An LED focusing method comprising:
providing a plurality of radially arranged LED adjusting modules, wherein each LED adjusting module includes an LED and a light guide plate, where the LED is located on the same level as the light guide plate and the LED is provided with an optical member to enable a light beam emitted by the LED to radiate towards the light guide plate, which, in turn, radiates said light beam in a predetermined direction and a focal point, thereby defining a predetermined focus range; and
adjusting the LED or the light guide plate to a predetermined angle relative to a horizontal plane resulting in variation of an incident angle of the light beam emitted from the LED into the light guide plate and simultaneously altering position of said focal point, thereby changing a size of said predetermined focus range.

11. The LED focusing method as claimed in claim 10, wherein the light guide plate has on an end proximate to the LED permitting extension of a revolving axle so that the light guide plate is rotatable about said revolving axle.

12. The LED focusing method as claimed in claim 11, wherein the light guide plate further has a distal end away from the LED and connected to an adjustment member via a rod so that rotation of the light guide plate is adjusted through the adjusting member.

13. The LED focusing method as claimed in claim 10, wherein the method is capable of being used in a medical illumination device.

14. An LED focusing structure comprising:
a plurality of radially arranged LED adjusting modules, each LED adjusting module including
an LED, and
a light guide plate;
wherein, the LED and the light guide plate are located on the same level and the LED is provided with an optical member so as to enable a light beam emitted from the LED to radiate towards the light guide plate in a predetermined direction, thereby forming a focal point and defining a predetermined focus range; wherein the LED or the light guide plate is adjusted via an adjustment mechanism to a predetermined angle relative to a horizontal plane results in variation of an incident angle of a light beam emitted from the LED into the light guide plate-and simultaneously altering position of said focal point, thereby changing a size of said predetermined focus range.

15. The LED focusing structure as claimed in claim 14, wherein the adjusting mechanism includes a revolving axle extending through an end of the light guide plate adjacent to the LED so as to permit rotation of the light guide plate about the revolving axle.

16. The LED focusing structure as claimed in claim 15, wherein the light guide plate further has a distal end away from the LED and connected to said adjustment mechanism via a rod so that rotation of the light guide plate is adjusted through the adjustment mechanism.

17. The LED focusing structure as claimed in claim 14, wherein the LED focusing structure is capable of being applied to a medical illumination device.
